(19) United States
(12) Patent Application Publication
(10) Pub. No.: US 2023/0349316 A1
(43) Pub. Date: Nov. 2, 2023

(54) MODEL BASED CONTROL OF PUMPS IN MULTI-PATH COOLING SYSTEMS

(71) Applicants: Craig Lindquist, Shelby Township, MI (US); Rezwanur Rahman, Auburn Hills, MI (US)

(72) Inventors: Craig Lindquist, Shelby Township, MI (US); Rezwanur Rahman, Auburn Hills, MI (US)

(21) Appl. No.: 17/731,556

(22) Filed: Apr. 28, 2022

(51) Int. Cl. F02B 29/04; F02B 29/02

(52) U.S. Cl. CPC F02B 29/0493; F02B 29/0443; F02B 29/02

(57) ABSTRACT

A multi-pump thermal system for a vehicle includes a coolant circuit having a first loop and a second loop, a first pump disposed on the coolant circuit, and a second pump disposed on the coolant circuit. A first component on the first loop is configured to be cooled by a first flow of coolant passing through the first loop. A second component on the second loop is configured to be cooled by a second flow of coolant passing through the second loop. A controller is in signal communication with the first and second pumps, and is programmed to (i) utilize a physics based model to determine speeds of the first and second pumps to generate predetermined coolant flow targets in the coolant circuit to meet predetermined cooling requirements of the first and second components, and (ii) operate the first and second pumps at the determined speeds.

### FIELD

The present application relates generally to vehicle cooling systems and, more particularly, to a vehicle cooling system with physics-based model pump control.

### BACKGROUND

Modern vehicles commonly include multiple devices such as electric motors and turbocharged engines that are cooled on a single cooling circuit. Because the cooling circuit has different coolant flow requirements for each device, more than one pump is often required to achieve cooling of individual components efficiently. In order to provide the necessary cooling, conventional cooling systems depend on accurate calibration tables (e.g., databases) to determine target pump speed. Such “lookup tables” are generated via simulation and/or testing and are configured to incorporate interdependency between pump1 and pump2 RPM's. Target flows are then determined by controller (e.g., ECM), pump supplier information, etc. However, since it is challenging to address interaction between dual pumps based on rule-based strategies, such lookup tables are extremely large and consume large hardware memory.

For example, for a combination of two pump speeds (RPM1, RPM2), there exists a efficient solution which ensures the flow targets are met. A certain flow target can be generated from multiple combinations of RPM1, RPM2, which requires the large and complex lookup tables. This also requires a linear search through the lookup table that adds time complexity. Moreover, the properties of coolant vary considerably with temperature. Therefore, according to existing strategy, a 3D lookup table would be required in order to be accurate over a wide range of operating points. However, the current systems are 2D table based only on nominal fluid temperature (and only accurate at nominal fluid temperature) because a 3D table could potentially lead to significant memory consumption in the ECU. Additionally, since the table has a limited resolution, it does not return an exact solution and tends to choose slightly higher pump speeds than required. Accordingly, while such conventional cooling systems work for their intended purpose, it is desirable to provide improvement in the relevant art.

### SUMMARY

According to one example aspect of the invention, a multi-pump thermal system for a vehicle is provided. In one exemplary implementation, the multi-pump thermal system for a vehicle includes a coolant circuit having a first loop and a second loop, a first pump disposed on the coolant circuit, and a second pump disposed on the coolant circuit. A first component on the first loop is configured to be cooled by a first flow of coolant passing through the first loop. A second component on the second loop is configured to be cooled by a second flow of coolant passing through the second loop. A controller is in signal communication with the first and second pumps, and is programmed to (i) utilize a physics based model to determine speeds of the first and second pumps to generate predetermined coolant flow targets in the coolant circuit to meet predetermined cooling requirements of the first and second components, and (ii) operate the first and second pumps at the determined speeds.

In addition to the foregoing, the described system may include one or more of the following features: wherein the controller is programmed to solve continuity and energy balance equations in the first and second loops when utilizing the physics based model; wherein the controller does not require a lookup table; wherein the controller does not utilize rule-based control to operate the first and second pumps; wherein the controller receives the predetermined coolant flow targets from vehicle thermal controls; wherein the controller is configured to receive at least one of bench test data, simulation data, and supplier pressure loss data for the first and second pumps; and wherein the controller is further programmed to determine pressure loss coefficients (C_{i,j}) in a plurality of branch conduits of the coolant circuit.

In addition to the foregoing, the described system may include one or more of the following features: wherein the controller is further programmed to solve physics-based model mass and energy equations of the coolant circuit to determine pump head rises (H) needed in each of the plurality of branch conduits; wherein the controller receives pump performance data for the first and second pumps; wherein the controller is configured to solve a plurality of quadratic equations utilizing the determined pressure loss coefficients, pump head rises, and pump performance data to determine the speeds of the first and second pumps.

In addition to the foregoing, the described system may include one or more of the following features: wherein the coolant circuit further includes a first branch conduit on the first loop, a second branch conduit on the second loop, and a third branch conduit having a radiator; wherein the first component is a charge air cooler, and the second component is at least one of electronics and an electric motor; wherein the controller is further programmed to determine the speed (w) of the first pump utilizing a first algorithm:

$${A}_{1} {ω}^{2} + ( {B}_{1} \frac{{\dot{m}}_{1} + {\dot{m}}_{2}}{ρ} - {C}_{1} ) ω - {{D}_{1} ( \frac{{\dot{m}}_{1} + {\dot{m}}_{2}}{ρ} )}^{2} - {E}_{1} \frac{{\dot{m}}_{1} + {\dot{m}}_{2}}{ρ} - {F}_{1} - \frac{[ {C}_{21} \frac{μ}{ρ} {\dot{m}}_{1} + {C}_{22} \frac{{\dot{m}}_{1}^{2}}{ρ} + {C}_{1 , 1} \frac{μ}{ρ} ( {\dot{m}}_{1} + {\dot{m}}_{2} ) + {C}_{12} \frac{( {\dot{m}}_{1} + {\dot{m}}_{2} )}{ρ} ]}{ρ g} = 0$$

and determine the speed (w) of the second pump utilizing a second algorithm:

$${A}_{2} {ω}^{2} + ( {B}_{2} \frac{{\dot{m}}_{2}}{ρ} - {C}_{2} ) ω - {{D}_{2} ( \frac{{\dot{m}}_{2}}{ρ} )}^{2} - {E}_{2} \frac{{\dot{m}}_{2}}{ρ} - {F}_{2} - \frac{[ {C}_{31} \frac{μ}{ρ} {\dot{m}}_{2} + {C}_{32} \frac{{\dot{m}}_{2}^{2}}{ρ} - {C}_{2 , 1} \frac{μ}{ρ} {\dot{m}}_{1} - {C}_{22} \frac{{\dot{m}}_{1}^{2}}{ρ} ]}{ρ g} = 0$$

where A_{P}, B_{P}, C_{P}, D_{P}, E_{P}, and F_{P} (where _{P} indicates the first pump or the second pump) are pump specific constants derived from pump performance data, which provide a 3D surface fit of a pump performance map, \dot{m}₁ is the mass flow of coolant in the first branch conduit, \dot{m}₂ is the mass flow of coolant in the second branch conduit, (ρ) is the coolant density, (g) is gravitational acceleration, (C_{i,j}) is a pressure loss coefficient in the i^{th} branch conduit, C_{i,2} is a slope of linear shaped data, and C_{i,1} is a y-intercept of the linear shaped data, and μ is the viscosity of the coolant.

According to one example aspect of the invention, a multi-pump thermal system for a vehicle is provided. In one exemplary implementation, a method of operating a multi-pump thermal system for a vehicle is provided. The system includes a coolant circuit having a first loop and a second loop, a first pump disposed on the coolant circuit, a second pump disposed on the coolant circuit, a first component on the first loop configured to be cooled by a first flow of coolant passing through the first loop, a second component on the second loop configured to be cooled by a second flow of coolant passing through the second loop, and a controller in signal communication with the first and second pumps.

The method includes via the controller, utilizing a physics-based model to determine speeds of the first and second pumps to generate predetermined coolant flow targets in the coolant circuit to meet predetermined cooling requirements of the first and second components, and operating, via the controller, the first and second pumps at the determined speeds.

In addition to the foregoing, the described system may include one or more of the following features: wherein the controller determines the speeds of the first and second pumps without a lookup table; receiving, at the controller, the predetermined coolant flow targets from vehicle thermal controls; receiving, at the controller, at least one of bench test data, simulation data, and supplier pressure loss data for the first and second pumps; determining, with the controller, pressure loss coefficients (C_{i,j}) in a plurality of branch conduits of the coolant circuit; solving, with the controller, physics-based model mass and energy equations of the coolant circuit to determine pump head rises (H) needed in each of the plurality of branch conduits; receiving, via the controller, pump performance data for the first pump and the second pump; and solving, via the controller, (i) continuity and energy balance equations in the first and second loops, and (ii) a plurality of quadratic equations utilizing the determined pressure loss coefficients, pump head rises, and pump performance data to determine the speeds of the first and second pump.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example dual pump thermal system in accordance with the principles of the present disclosure;

FIG. 2 is a schematic illustration of an example method of operating the dual pump thermal system of FIG. 1, in accordance with the principles of the present disclosure; and

FIG. 3 is a schematic illustration of another example dual pump thermal system in accordance with the principles of the present disclosure

### DETAILED DESCRIPTION

Described herein are systems and methods for physics-based model control of pump speed (rpm) in a multi-pump system based on conservation of mass and energy laws. In this way, pump control does not have or require lookup table databases of rule-based control, which in turn requires pre-sorting and linear searching through large lookup tables to eventually check if the combination of pump1 and pump2 speed ensures lower power than each previously searched combination. Accordingly, the systems and methods described herein are much simpler and more memory efficient.

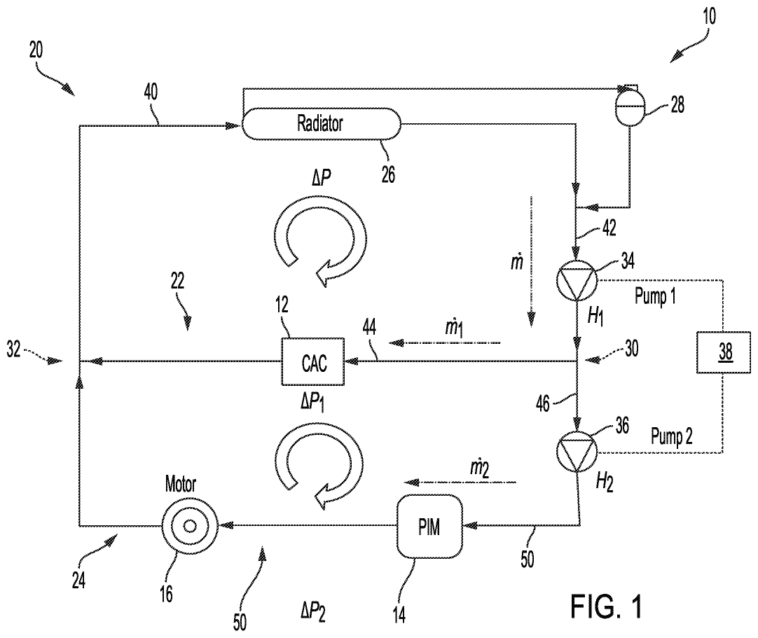

With initial reference to FIG. 1, an example vehicle thermal system is illustrated and generally identified at reference numeral 10. The thermal system 10 is configured to provide heating/cooling to various components of the vehicle such as a charge air cooler (CAC) 12, power inverter module (PIM) 14, and electric motor 16. However, thermal system 10 may include various other components such as, for example, a high voltage battery system. In the example embodiment, the thermal system 10 is a high temperature circuit 20 configured to circulate a heat transfer fluid or coolant (e.g., water, ethylene glycol, etc.) therein.

As shown in the illustrated example, the high temperature circuit 20 generally includes a first loop 22, a second loop 24, a high temperature radiator 26, and an overflow bottle 28. It will be appreciated that circuit 20 is merely one example and the model-based multi-pump control describe herein may be utilized with numerous thermal system architectures and configurations. A first node 30 defines a coolant split between the first and second loops 22, 24, and a second node 32 defines a convergence of the first and second loops 22, 24. A first pump 34 is disposed on the first/second loops 22, 24 and a second pump 36 is disposed on the second loop 24.

Thermal system 10 includes a controller 38 such as an engine control unit (ECU), which is in signal communication with the first and second pumps 34, 36. As described herein in more detail, controller 38 utilizes a physics-based model to determine a pump speed to achieve a flow target for efficient cooling of a thermally coupled component (in this case CAC 12, PIM 14, motor 16). As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

In the example implementation, a first branch conduit 40 directs heated coolant to the high temperature radiator 26 where the heated coolant is cooled by ambient air and/or an airflow created by a fan (not shown). The coolant is then directed to the first pump 34 via a coolant return line 42. Coolant exits the first pump 34 to the first node 30 where a first portion of coolant is directed to a second branch conduit 44 of the first loop 22, and a second portion of coolant is directed to a second return line 46 of the second loop 24. The first portion of coolant is subsequently utilized to cool the CAC 12, which is thermally coupled to the first loop 22. The heated coolant then passes through the second node 32 and into the first branch conduit 40 where the cycle is then repeated.

In the example embodiment, the second portion of coolant from the first node 30 is directed to the second pump 36 via the second coolant return line 46. The second pump 36 supplies coolant via a third branch conduit 50 to provide cooling to the PIM 14 and motor 16, which are thermally coupled to the second loop 24. The heated coolant then passes through the second node 32 and into the first branch conduit 40 where the cycle is then repeated.

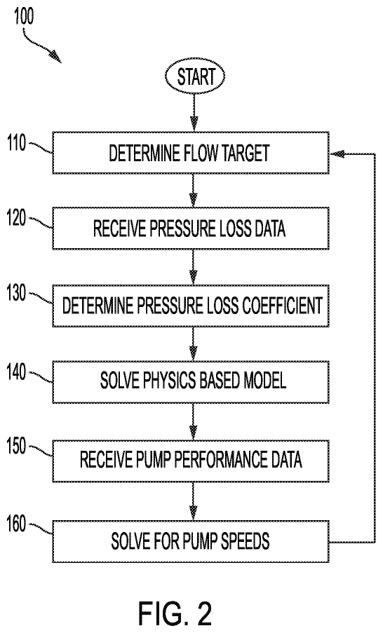

With reference now to FIG. 2, a method 100 of operating the dual pump thermal system 10 will be described in more detail. As discussed above, in the example embodiment, the thermal system 10 utilizes a model-based strategy to determine the operational speeds of the first and second pumps 34, 36 in the dual pump thermal system to achieve the required target flows for providing the desired cooling to the components (CAC 12, PIM 14, motor 16).

The method begins at step 110 where controller 38 determines the flow target in each of the first and second loops 22, 24 to provide the desired cooling to the component(s) in that loop. In the example embodiment, the flow target is provided by the vehicle thermal controls and is a function of various factors such as coolant temperature, motor torque, etc. In other words, what mass flow is required to cool the components in the first loop 22, and what mass flow is required to cool the components in the second loop 24 at a given time under given conditions. However, it will be appreciated that flow targets may be provided by any suitable source.

At step 120, controller 38 receives at least one of (i) bench test data, (ii) simulation data, and (iii) pump supplier's data for pressure loss. At step 130, controller 38 determines pressure loss coefficients C_{i,j}. The coefficients are found by fitting data that has a linear shape, e.g., where i is the i^{th} branch conduit, C_{i,2} is the slope, and C_{i,1} is the y-intercept. If bench test or simulation data is received, controller 38 determines the pressure loss coefficients C_{i,j}, for example, via linear regression. If the bench test or simulation data is unavailable, controller 38 determines the pressure loss coefficients C_{i,j} with the pump supplier data. At step 140, controller 38 solves physics-based model mass and energy balance equations to calculate pump head rise ‘H’ needed in each of the first and second branches 44, 50.

At step 150, controller 38 receives/accesses supplier given pump performance data (e.g., functions of pump speed and flow rate for a specific pump model). At step 160, controller 38 solves the algorithmic quadratic equations using the needed pump head rise (H₁, H₂) and the pump performance data to thereby calculate the required speed (rpm) for each of the first and second pumps 34, 36. Control then loops or returns to step 110 and the operation is repeated. The method 100 will be discussed in more detail below.

In the example embodiment, the physics-based model control begins with continuity and energy balance laws in each loop. The example thermal system 10 shown in FIG. 1 includes two loops 22, 24. The continuity equation can be applied at the first node 30 where total mass flow from the first pump 34 is \dot{m} that splits into two parallel branches (44, 50) with mass flow \dot{m}₁ directed to the CAC 12, and mass flow \dot{m}₂ directed to the PIM 14 and motor 16. These values are determined in step 110 via vehicle thermal controls. As such, the continuity equations at the first node 30 are:

\dot{m}=\dot{m}₁+\dot{m}₂ (1)

For energy balance in the first loop 22, pressure loss across the radiator 26 and CAC 12 is balanced by pressure rise from the first pump 34:

ΔP+ΔP₁−H₁ρg=0 (2)

For energy balance in the second loop 24, pressure loss across the CAC 12 is subtracted in order to ensure energy balance since CAC pressure loss is already considered in the first loop 22:

ΔP₂−ΔP₁−H₂ρg=0 (3)

The head rise H₁ of the first pump 34 is divided by coolant density (ρ) and gravitational acceleration (g). Equations (1-3) are solved for flow in each branch 44, 50 using iterative solver if pressure rise from the pumps is known based on a given pump speed. In this case, flow targets are known (e.g., CAC target flow is determined by controller 38, PIM target flow is based on temperature, etc.). This eliminates the possibility of numerical iterative algorithm.

In step 120, controller 38 determines pressure loss coefficients C_{i,j}. More specifically, controller 38 evaluates the pressure loss coefficients from bench test or simulations. If these are unavailable, supplier's data for pressure loss in Pa with varying flow can be used. A generic pressure loss equation in any component or collection of plumbing and components is:

$$Δ P = {C}_{1} \frac{μ}{ρ} \dot{m} + {C}_{2}^{2} \frac{{\dot{m}}^{2}}{ρ} \qquad ( 4 )$$

Here, C₁ and C₂ are unknown and ρ=ρ(T), μ=μ(T), are density and viscosity of the coolant, which are functions of temperature. These can be determined from bench test data, vehicle test data, simulations, or supplier data. Equation (4) can be converted into a linear form for the ease of regression:

$$X = \frac{\dot{m}}{μ} \qquad ( 5 )$$

$$Y = \frac{Δ P}{μ \frac{\dot{m}}{ρ}} \qquad ( 6 )$$

C₁, C₂ are evaluated by fitting the line: Y=C₂X+C₁.

This determines the coefficients that will be used in equations (7) and (8) through linear regression. In the example embodiment, the second pump 36 has a lower flow than total flow from the first pump 34. The linear regression is able to fit the pressure loss model according to the bench test data. If bench test data is unavailable, equations (5) and (6) can be applied to supplier pump data. Based on the fitted parameters, equation (4) is applied to calculate pressure loss in the second loop 24.

In step 140, controller 38 solves physics-based model mass and energy balance equations to calculate pump head rise (H₁, H₂) needed in each of the first and second branches 44, 50. Based on Darcy's law, pressure loss is a quadratic function of flowrate, hence:

$${H}_{1} = \frac{[ {C}_{21} \frac{μ}{ρ} {\dot{m}}_{1} + {C}_{22} \frac{{\dot{m}}_{1}^{2}}{ρ} + {C}_{11} \frac{μ}{ρ} ( {\dot{m}}_{1} + {\dot{m}}_{2} ) + {C}_{12} \frac{( {\dot{m}}_{1} + {\dot{m}}_{2} )}{ρ} ]}{ρ g} \qquad ( 7 )$$

$${H}_{2} = \frac{[ {C}_{31} \frac{μ}{ρ} {\dot{m}}_{2} + {C}_{32} \frac{{\dot{m}}_{2}^{2}}{ρ} - {C}_{21} \frac{μ}{ρ} {\dot{m}}_{1} - {C}_{22} \frac{{\dot{m}}_{2}^{2}}{ρ} ]}{ρ g} \qquad ( 8 )$$

Once the pressure loss is fitted into the non-linear model (equation 4), equations (7) and (8) can be rewritten in order to calculate the pump speed. Pressure heads (left side of equations (7) and (8)) can be fitted to functions of pump speed and flowrate. Using supplier given pump performance data (e.g., functions of pump speed and flow rate), the following equations are constructed:

$${A}_{1} {ω}^{2} + ( {B}_{1} \frac{{\dot{m}}_{1} + {\dot{m}}_{2}}{ρ} - {C}_{1} ) ω - {{D}_{1} ( \frac{{\dot{m}}_{1} + {\dot{m}}_{2}}{ρ} )}^{2} - {E}_{1} \frac{{\dot{m}}_{1} + {\dot{m}}_{2}}{ρ} - {F}_{1} - \frac{[ {C}_{21} \frac{μ}{ρ} {\dot{m}}_{1} + {C}_{22} \frac{{\dot{m}}_{1}^{2}}{ρ} + {C}_{1 , 1} \frac{μ}{ρ} ( {\dot{m}}_{1} + {\dot{m}}_{2} ) + {C}_{12} \frac{( {\dot{m}}_{1} + {\dot{m}}_{2} )}{ρ} ]}{ρ g} = 0 \qquad ( 9 )$$

$${A}_{2} {ω}^{2} + ( {B}_{2} \frac{{\dot{m}}_{2}}{ρ} - {C}_{2} ) ω - {{D}_{2} ( \frac{{\dot{m}}_{2}}{ρ} )}^{2} - {E}_{2} \frac{{\dot{m}}_{2}}{ρ} - {F}_{2} - \frac{[ {C}_{31} \frac{μ}{ρ} {\dot{m}}_{2} + {C}_{32} \frac{{\dot{m}}_{2}^{2}}{ρ} - {C}_{2 , 1} \frac{μ}{ρ} {\dot{m}}_{1} - {C}_{22} \frac{{\dot{m}}_{1}^{2}}{ρ} ]}{ρ g} = 0 \qquad ( 10 )$$

where A_{P}, B_{P}, C_{P}, D_{P}, E_{P}, and F_{P} (where _{P} is pump1 or pump2) are pump specific constants derived from pump performance data from the pump supplier (or measured) which provide a 3D surface fit of the pump performance map. As such, the constants represent fitting coefficients of the pump performance. At step 150, controller 38 receives/accesses the supplier given pump performance data. At step 160, controller 38 solves quadratic equations (9) and (10) using the needed pump head rise (H₁, H₂) and the pump performance data (A_{P}, B_{P}, C_{P}, D_{P}, E_{P}, and F_{P}) to thereby calculate the required speed ω (rpm) for each of the first and second pumps 34, 36.

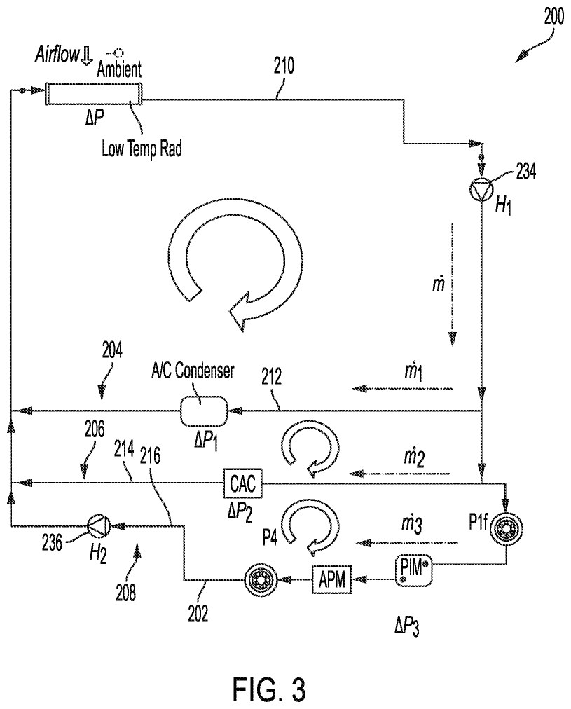

The example algorithm can be adapted and the concept of continuity and conservation of energy can similarly be used to develop flow and pressure balance equations for other systems having more pumps and/or branches. For example, FIG. 3 illustrates a thermal system 200, which includes a fourth branch conduit 202, dual pumps 234, 236, and three loops 204, 206, 208, and four conduit branches 210, 212, 214, 216. Hence, the balance equations become:

\dot{m}=\dot{m}₁+\dot{m}₂+\dot{m}₃ (11)

ΔP+ΔP₁−H₁ρg=0 (12)

ΔP₂−ΔP₁=0 (13)

ΔP₃−ΔP₂−H₂ρg=0 (14)

Equations (4-10) are subsequently utilized as previously mentioned, but would be modified to include the new branch conduit.

Described herein are systems and methods for physics-based model control of pump speed (rpm) in a multi-pump system based on conservation of mass and energy laws. The systems advantageously: obviate the need for large calibration parameters or tables; introduce analytical form for calculating pump speed (Eqns. (9) and (10)); significantly simplify control strategy; incorporate the effect of temperature variation (Eqn. (6)) without needing any multidimensional lookup tables; generalize the model for any architecture; eliminate linear search through a large lookup table; and incorporate inherent physics of the system, which cannot be addressed in conventional controls strategies. Accordingly, provided is a model-based pump speed controller that is capable of predicting pump speed with good accuracy without occupying large hardware memory.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A multi-pump thermal system for a vehicle, comprising:
a coolant circuit having a first loop and a second loop;
a first pump disposed on the coolant circuit;
a second pump disposed on the second loop, wherein coolant exiting the first pump is split into a first portion that is directed to the first loop, and a second portion that is directed to an inlet of the second pump;
a first component on the first loop configured to be cooled by the first portion of coolant passing through the first loop;
a second component on the second loop configured to be cooled by the second portion of coolant passing through the second loop; and
a controller in signal communication with the first and second pumps, the controller programmed to:
utilize a physics based model to determine speeds of the first and second pumps to generate predetermined coolant flow targets in the coolant circuit to meet predetermined cooling requirements of the first and second components, wherein the controller determines the speeds of the first and second pumps without utilizing a lookup table; and
operate the first and second pumps at the determined speeds.

2. The system of claim 1, wherein the controller is programmed to solve continuity and energy balance equations in the first and second loops when utilizing the physics based model, and wherein after respectively cooling the first and second components, the first portion of coolant and the second portion of coolant converge and are directed to a radiator before returning to an inlet of the first pump.

3. The system of claim 1, wherein the controller receives the predetermined coolant flow targets from vehicle thermal controls, and wherein the first pump and the second pump are in parallel and the coolant circuit is without a valve.

4. The system of claim 1, wherein the controller is configured to meet the predetermined cooling requirements of the first and second components only by adjusting the speeds of the first and second pumps with the physics based model.

5. The system of claim 4, wherein the controller is further programmed to:
receive at least one of bench test data, simulation data, and supplier pressure loss data for the first and second pumps; and
determine pressure loss coefficients (C_{i,j}) in a plurality of branch conduits of the coolant circuit.

6. The system of claim 5, wherein the controller is further programmed to solve physics-based model mass and energy equations of the coolant circuit to determine pump head rises (H) needed in each of the plurality of branch conduits.

7. The system of claim 6, wherein the controller receives pump performance data for the first and second pumps.

8. The system of claim 7, wherein the controller is configured to solve a plurality of quadratic equations utilizing the determined pressure loss coefficients, pump head rises, and pump performance data to determine the speeds of the first and second pumps.

9. The system of claim 1, wherein the coolant circuit further includes:
a first branch conduit having a radiator;
a second branch conduit on the first loop; and
a third branch conduit on the second loop,
wherein the second and third branch conduits converge to supply the first and second portions of coolant to the first branch.

10. The system of claim 9, wherein the first component is a charge air cooler, and the second component is at least one of electronics and an electric motor.

11. The system of claim 9, wherein the controller is further programmed to:
determine the speed (ω) of the first pump utilizing a first algorithm:
$${A}_{1} {ω}^{2} + ( {B}_{1} \frac{{\dot{m}}_{1} + {\dot{m}}_{2}}{ρ} - {C}_{1} ) ω - {{D}_{1} ( \frac{{\dot{m}}_{1} + {\dot{m}}_{2}}{ρ} )}^{2} - {E}_{1} \frac{{\dot{m}}_{1} + {\dot{m}}_{2}}{ρ} - {F}_{1} - \frac{[ {C}_{21} \frac{μ}{ρ} {\dot{m}}_{1} + {C}_{22} \frac{{\dot{m}}_{1}^{2}}{ρ} + {C}_{1 , 1} \frac{μ}{ρ} ( {\dot{m}}_{1} + {\dot{m}}_{2} ) + {C}_{12} \frac{{( {\dot{m}}_{1} + {\dot{m}}_{2} )}^{2}}{ρ} ]}{ρ g} = 0$$
determine the speed (ω) of the second pump utilizing a second algorithm:
$${A}_{2} {ω}^{2} + ( {B}_{2} \frac{{\dot{m}}_{2}}{ρ} - {C}_{2} ) ω - {{D}_{2} ( \frac{{\dot{m}}_{2}}{ρ} )}^{2} - {E}_{2} \frac{{\dot{m}}_{2}}{ρ} - {F}_{2} - \frac{[ {C}_{31} \frac{μ}{ρ} {\dot{m}}_{2} + {C}_{32} \frac{{\dot{m}}_{2}^{2}}{ρ} - {C}_{2 , 1} \frac{μ}{ρ} {\dot{m}}_{1} - {C}_{22} \frac{{\dot{m}}_{1}^{2}}{ρ} ]}{ρ g} = 0$$
where A_{P}, B_{P}, C_{P}, D_{P}, E_{P}, and F_{P} (where _{P} indicates the first pump or the second pump) are pump specific constants derived from pump performance data, which provide a 3D surface fit of a pump performance map,
\dot{m}₁ is the mass flow of coolant in the first branch conduit,
\dot{m}₂ is the mass flow of coolant in the second branch conduit,
(ρ) is the coolant density,
(g) is gravitational acceleration,
(C_{i,j}) is a pressure loss coefficient in the i^{th} branch conduit, C_{i,2} is a slope of linear shaped data, and C_{i,1} is a y-intercept of the linear shaped data;
μ is the viscosity of the coolant.

12. A method of operating a multi-pump thermal system for a vehicle, the system including a coolant circuit having a first loop and a second loop, a first pump disposed on the coolant circuit, a second pump disposed on the second loop, wherein coolant exiting the first pump is split into a first portion that is directed to the first loop, and a second portion that is directed to an inlet of the second pump, a first component on the first loop configured to be cooled by the first portion of coolant passing through the first loop, a second component on the second loop configured to be cooled by the second portion of coolant passing through the second loop, and a controller in signal communication with the first and second pumps, the method comprising:
via the controller, utilizing a physics-based model to determine speeds of the first and second pumps to generate predetermined coolant flow targets in the coolant circuit to meet predetermined cooling requirements of the first and second components, wherein the controller determines the speeds of the first and second pumps without a lookup table; and
operating, via the controller, the first and second pumps at the determined speeds.

13. The method of claim 12, further comprising receiving, at the controller, the predetermined coolant flow targets from vehicle thermal controls.

14. The method of claim 12, further comprising receiving, at the controller, at least one of bench test data, simulation data, and supplier pressure loss data for the first and second pumps.

15. The method of claim 14, further comprising determining, with the controller, pressure loss coefficients (C_{i,j}) in a plurality of branch conduits of the coolant circuit.

16. The method of claim 15, solving, with the controller, physics-based model mass and energy equations of the coolant circuit to determine pump head rises (H) needed in each of the plurality of branch conduits.

17. The method of claim 16, receiving, via the controller, pump performance data for the first pump and the second pump.

18. The method of claim 17, solving, via the controller, (i) continuity and energy balance equations in the first and second loops, and (ii) a plurality of quadratic equations utilizing the determined pressure loss coefficients, pump head rises, and pump performance data to determine the speeds of the first and second pump.
